(19) United States
(12) Patent Application Publication
(10) Pub. No.: US 2022/0011499 A1
(43) Pub. Date: Jan. 13, 2022

(54) CUTTING TOOL AND METHOD FOR MANUFACTURING OPTICAL FIBER PREFORM

(71) Applicant: SUMITOMO ELECTRIC INDUSTRIES, LTD., Osaka (JP)

(72) Inventors: Tetsuya Nakanishi, Osaka (JP); Takuji Nagashima, Osaka (JP)

(73) Assignee: SUMITOMO ELECTRIC INDUSTRIES, LTD., Osaka (JP)

(21) Appl. No.: 17/483,970

(22) Filed: Sep. 24, 2021

Related U.S. Application Data
(63) Continuation of application No. PCT/JP2020/011788, filed on Mar. 17, 2020.

(30) Foreign Application Priority Data
Mar. 28, 2019 (JP) 2019-062449

(51) Int. Cl. G02B 6/02; B24B 7/22

(52) U.S. Cl. CPC G02B 6/02042; B24B 7/22

(57) ABSTRACT

A cutting tool includes: a shank part; and a cutting part provided at one end of the shank part. The cutting part includes a first region provided at one end of the cutting tool, and a second region located closer to a center of the cutting tool than the first region. Abrasive grains adhere to the first region and the second region. An average grain diameter of the abrasive grains in the second region is smaller than an average grain diameter of the abrasive grains in the first region.

### CROSS-REFERENCE TO RELATED APPLICATION(S)

This application is a continuation of PCT application No. PCT/JP2020/011788, which was filed on Mar. 17, 2020 based on Japanese Patent Application No. 2019-062449 filed on Mar. 28, 2019, the contents of which are incorporated herein by reference.

### BACKGROUND OF THE INVENTION

### Technical Field

The present disclosure relates to a cutting tool and a method for manufacturing an optical fiber preform.

### Background Art

There is a case where an optical fiber preform having a core extending in a longitudinal direction is manufactured by a rod-in collapse method. In the rod-in collapse method, for example, a jacket material is made by forming holes extending in the longitudinal direction in a cylindrical glass body. Next, after inserting a core rod into the hole, the core rod and the jacket material are heated from the outside of the jacket material and integrated with each other to manufacture an optical fiber preform.

For example, Patent Literature 1 discloses a technology for manufacturing an optical fiber preform having one core extending in the longitudinal direction (hereinafter, referred to as a single-core optical fiber preform). Patent Literature 2 discloses a technology for manufacturing an optical fiber preform having a plurality of cores (hereinafter, referred to as a multi-core optical fiber preform).

### CITATION LIST

### Patent Literature

Patent Literature 1: JP-A-563-2826

Patent Literature 2: JP-A- S61-201633

### SUMMARY OF INVENTION

According to an aspect of the present disclosure, there is provided a cutting tool including: a shank part; and a cutting part provided at one end of the shank part, in which the cutting part includes a first region provided at one end of the cutting tool and a second region located closer to a center of the cutting tool than the first region, abrasive grains adhere to the first region and the second region, and an average grain diameter of the abrasive grains in the second region is smaller than an average grain diameter of the abrasive grains in the first region.

According to another aspect of the present disclosure, there is provided a method for manufacturing an optical fiber preform including a core extending in a longitudinal direction, the method including: preparing a jacket material by forming a hole from one end to another end of a glass body in an axial direction of the glass body by using the cutting tool according to the present disclosure; inserting a core rod into the hole; and integrating the jacket material and the core rod with each other by heating the jacket material.

### BRIEF DESCRIPTION OF DRAWINGS

FIG. 1 illustrates a sectional view illustrating an example of a multi-core optical fiber.

FIG. 2A is a front view illustrating a glass body used in a method for manufacturing an optical fiber preform according to an aspect of the present disclosure.

FIG. 2B is a sectional view of the glass body used in the method for manufacturing an optical fiber preform according to the aspect of the present disclosure.

FIG. 3A is a side view illustrating an example of a cutting tool according to the aspect of the present disclosure.

FIG. 3B is a front view illustrating an example of the cutting tool according to the aspect of the present disclosure.

FIG. 3C is a perspective view obtained by enlarging a cutting part, to which abrasive grains adhere, of the cutting tool of FIGS. 3A and 3B.

FIG. 4 is a sectional view including a center axis of the glass body in a process of preparing a jacket material according to an embodiment of the present disclosure.

FIG. 5 is a sectional view including a center axis of the jacket material, according to the embodiment of the present disclosure.

FIG. 6 is a sectional view including the center axis of the jacket material into which a core rod is inserted in a process of inserting the core rod according to the embodiment of the present disclosure.

FIG. 7 is a sectional view including a center axis of a glass body in a process of preparing a jacket material according to a modification example of the embodiment of the present disclosure.

FIG. 8 is a sectional view including a center axis of the jacket material, according to the modification example of the embodiment of the present disclosure.

FIG. 9 is a sectional view including the center axis of the jacket material into which a core rod is inserted in a process of inserting the core rod according to the modification example of the embodiment of the present disclosure.

FIG. 10 is a conceptual view illustrating a process of integration according to the embodiment of the present disclosure.

FIG. 11 is a sectional view illustrating an example of the jacket material.

FIG. 12A is a front view illustrating another example of the cutting tool.

FIG. 12B is a front view illustrating another example of the cutting tool.

### DESCRIPTION OF EMBODIMENTS

[Problems to be Solved by Present Disclosure]

In a jacket pipe for manufacturing a single-core optical fiber preform, a hole is provided at the center of the jacket pipe. In a case where the jacket pipe is heated from the outside, the jacket pipe deforms while maintaining a symmetrical state with respect to the center axis of the jacket pipe. In other words, the inner circumference of the hole shrinks uniformly toward the center axis of the hole, and the inner wall of the hole comes into contact with the core rod. At the same time as the inner circumference of the hole shrinks, the inner wall of the hole becomes smooth. However, when the inner wall of the hole comes into contact with the core rod before the roughness of the inner wall of the hole becomes sufficiently small, there is a case where void remains at the boundary part between the inner wall of the hole and the core rod. When an optical fiber preform in which void exists is drawn, the outer diameter variation of the optical fiber increases and the mechanical strength of the optical fiber deteriorates.

In a case where the multi-core optical fiber preform is manufactured by the rod-in collapse method, when the clearance between the inner diameter of the hole and the outer diameter of the core rod decreases, the positional accuracy of the core increases. However, when the clearance is small, the inner wall of the hole is likely to come into contact with the core rod before the roughness of the inner wall of the hole becomes sufficiently small, and thus, void is more likely to remain.

In some multi-core optical fiber preforms, the holes are provided other than at the center of the jacket pipe. In a case where the jacket pipe is heated from the outside, the vicinity of the outer circumference of the jacket pipe is heated more strongly than the center of the jacket pipe. Therefore, it is difficult to keep the roughness of the inner wall of the hole provided other than at the center of the jacket pipe to be equal at the entire circumference of the inner wall in one cross section of the jacket pipe. Particularly, in a case of the hole provided in the vicinity of the outer circumference of the jacket pipe, void is likely to remain because the inner wall of the hole can come into contact with the core rod before the roughness of the part of the inner wall of the hole close to the center of the jacket pipe becomes sufficiently small.

[Description of Embodiments of Present Disclosure]

First, the contents of embodiments of the present disclosure will be listed and described.

(1) There is provided a cutting tool including: a shank part; and a cutting part provided at one end of the shank part, in which the cutting part includes a first region provided at one end of the cutting tool and a second region located closer to a center of the cutting tool than the first region, abrasive grains adhere to the first region and the second region, and an average grain diameter of the abrasive grains in the second region is smaller than an average grain diameter of the abrasive grains in the first region. Since the grain diameter of the abrasive grains in the second region is smaller than the grain diameter of the abrasive grains in the first region, the present disclosure can reduce the roughness of the inner wall of the hole in the second region while ensuring the productivity of hole opening in the first region. Accordingly, the present disclosure can obtain an optical fiber preform in which void is unlikely to remain at the boundary part between the inner wall of the hole and the core rod without deteriorating the productivity of the hole opening.

(2) In an aspect of the cutting tool according to the present disclosure, the abrasive grains are diamond grains. By using the diamond grains, a hole having a smooth inner wall can be easily formed in the glass body.

(3) In an aspect of the cutting tool according to present disclosure, the average grain diameter of the abrasive grains in the first region is 100 μm or greater and the average grain diameter of the abrasive grains in the second region is less than 100 μm. Since the average grain diameter of the abrasive grains in the first region is 100 μm or greater, the present disclosure can maintain a high processing speed of the hole opening. Furthermore, since the average grain diameter of the abrasive grains in the second region is less than 100 μm, the present disclosure can obtain a smooth inner wall even at such processing speed.

(4) In an aspect of the cutting tool according to the present disclosure, an outer diameter of the second region is greater than an outer diameter of the first region. Since the outer diameter of the second region is greater than the outer diameter of the first region, the second region can reliably process the inner wall of the hole after the first region has processed the hole. Accordingly, the present disclosure can reliably obtain a hole having a smooth inner wall.

(5) In an aspect of the cutting tool according to the present disclosure, a difference between the outer diameter of the second region and the outer diameter of the first region is in a range of 10 μm or greater and to 300 μm or less. Since the difference between the outer diameter of the second region and the outer diameter of the first region is 10 μm or greater, even when the abrasive grains of the second region wear out, the second region can continue to process the inner wall of the hole. Furthermore, since the difference between the outer diameter of the second region and the outer diameter of the first region is 300 μm or less, the load on the second region during the processing does not increase, and the abrasive grain wear of the second region is reduced.

(6) According to an aspect of the present disclosure, there is provided a method for manufacturing an optical fiber preform including a core extending in a longitudinal direction, the method including: preparing a jacket material by forming a hole from one end to another end of a glass body in an axial direction of the glass body by using the cutting tool according to the present disclosure; inserting a core rod into the hole; and integrating the jacket material and the core rod with each other by heating the jacket material. Since the average grain diameter of the abrasive grains in the second region is smaller than the average grain diameter of the abrasive grains in the first region, the present disclosure can reduce the roughness of the inner wall of the hole in the second region while ensuring the productivity of hole opening in the first region. Accordingly, the present disclosure can obtain an optical fiber preform in which void is unlikely to remain at the boundary part between the inner wall of the hole and the core rod without deteriorating the productivity of the hole opening. Further, according to the present disclosure, by drawing the optical fiber preform manufactured in this manner, it is possible to manufacture an optical fiber in which the outer diameter variation of the optical fiber decreases and the mechanical strength does not deteriorate.

[Advantageous Effects of Invention]

An object of the present disclosure is to provide a method for manufacturing an optical fiber preform and a cutting tool in which void is unlikely to remain at the boundary part between the inner wall of the hole and the core rod without deteriorating the productivity of the hole opening.

[Description of Embodiments]

Hereinafter, with reference to the attached drawings, an appropriate embodiment of the method for manufacturing an optical fiber preform and a cutting tool according to the present disclosure will be described.

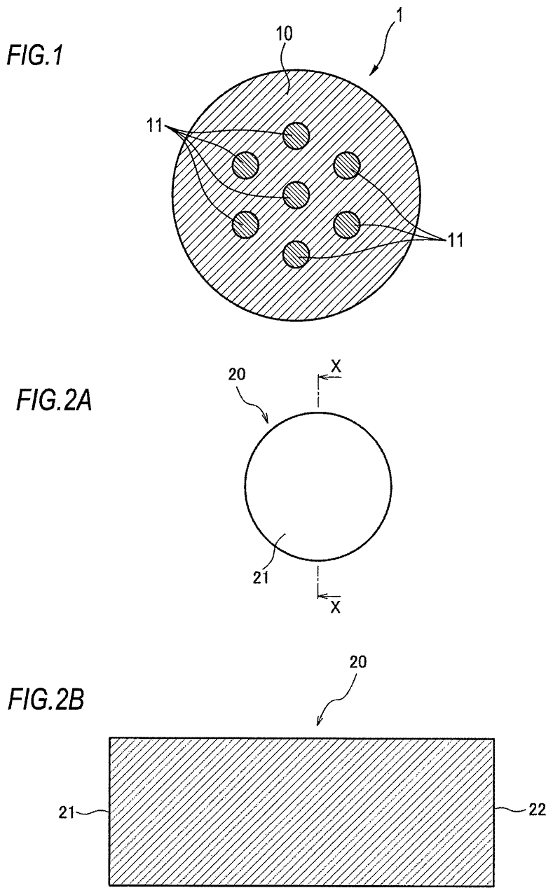

FIG. 1 illustrates a sectional view illustrating an example of a multi-core optical fiber 1. The multi-core optical fiber 1 has, for example, seven cores 11 in a cladding 10. The core 11 extends in the longitudinal direction of the multi-core optical fiber 1. The core 11 includes a center core disposed on the optical fiber center axis and outer circumferential cores disposed on vertices of a hexagon around the optical fiber center axis. Each core 11 includes a region with a refractive index higher than a refractive index of the cladding 10, and is configured to propagate light.

Rod-in collapse method is one of the methods for manufacturing an optical fiber preform. The rod-in collapse method includes: a process of preparing a jacket material by forming a hole from one end to another end of a cylindrical glass body in an axial direction of the cylindrical glass body, for example; a process of inserting a core rod into the hole of the jacket material; and a process of integrating the jacket material and the core rod with each other by heating the jacket material.

FIG. 2A is a front view of a glass body 20, which is used in the method for manufacturing an optical fiber preform according to an aspect of the present disclosure, when viewed from one end 21. FIG. 2B is an X-X line arrow sectional view of FIG. 2A. The glass body 20 is made of, for example, fluorine added silica glass or pure silica glass, and is cylindrical in shape. In a case where the optical fiber preform is manufactured by the rod-in collapse method to obtain the multi-core optical fiber 1, seven holes are provided in the glass body 20 from one end 21 to another end 22 in the axial direction with a drill-like tool.

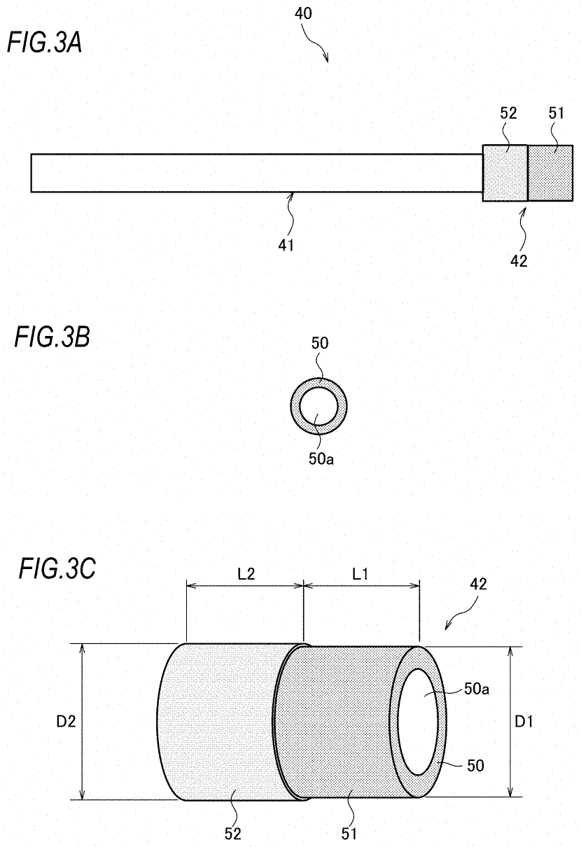

FIGS. 3A to 3C illustrate a cutting tool 40 used in the method for manufacturing an optical fiber preform according to the aspect of the present disclosure. FIG. 3A is a side view illustrating an example of the cutting tool 40. FIG. 3B is a front view illustrating an example of the cutting tool 40. FIG. 3C is a perspective view obtained by enlarging a cutting part, to which the abrasive grains adhere, of the cutting tool 40. The cutting tool 40 includes a shank part 41 and a cutting part 42. The shank part 41 is a hollow round bar made of metal, for example, and is configured such that a rotating force around an axial line extending in the longitudinal direction is applied to the shank part 41. The cutting part 42 is located in front of the shank part 41 (at one end of the cutting tool 40 and on the right side in FIG. 3A) and is configured to rotate together with the shank part 41.

The cutting part 42 is, for example, a hollow round bar, and is provided with a discharge path 50a concentric with the shank part 41 at the center on the cross section of the cutting part 42. The outer circumferential surface of the cutting part 42 includes a first region 51 provided at one end of the cutting tool 40 and a second region 52 located closer to the center of the cutting tool 40 than the first region 51. Specifically, the second region 52 is located behind (on the left side in FIG. 3A) the first region 51. The front end of the second region 52 is connected to the rear end of the first region 51, for example. A length L1 of the first region 51 and a length L2 of the second region 52 are both 5 mm, for example. The abrasive grains (for example, diamond grains) adhere to the first region 51 (including a tip end surface 50) and the second region 52, for example, by a multi-layered electrodeposition structure.

An average grain diameter of the abrasive grains is evaluated by the grain size specified in JIS_B_4130. An average grain diameter of the diamond grains in the first region 51 is 100 μm or greater (#140 or less in the grain size indication in JIS_B_4130), preferably 150 μm or greater (#100 or less in the grain size indication in JIS_B_4130). An average grain diameter of the diamond grains in the second region 52 is smaller than the average grain diameter of the diamond grains in the first region 51. Specifically, the average grain diameter of the diamond grains in the second region 52 is less than 100 μm, preferably 50 μm or less (#270 or greater in the grain size indication in JIS_B_4130). The average grain diameter is generally determined, for example, by a method of sorting the particles by a plurality of types of sieves. An average grain diameter of 105 μm corresponds to the grain size indication #140, an average grain diameter of 149 μm corresponds to #100, and an average grain diameter of 53 μm corresponds to #270.

In this manner, since the average grain diameter of the diamond grains in the first region 51 is 100 μm or greater, the present embodiment can maintain a high processing speed of the hole opening. When the average grain diameter of the diamond grains in the first region 51 is 150 μm or greater, the present embodiment can further increase the processing speed of the hole opening. Furthermore, since the average grain diameter of the diamond grains in the second region 52 is less than 100 μm, the present embodiment can obtain a smooth inner wall of the hole even at the processing speed. When the average grain diameter of the diamond grains in the second region 52 is 50 μm or less, the present embodiment can make the inner wall of the hole smoother.

The amount of protrusion of the abrasive grains adhered to the cutting part 42 is adjusted by dressing to form the cutting edge. The diamond may be synthetic diamond or may be natural diamond. Diamond is appropriate for processing glass, but cubic boron nitride (CBN) may also be used for the abrasive grains of the present disclosure.

In the example illustrated in the drawings, an example in which the first region 51 is connected to the second region 52 is described. However, a region to which the abrasive grains do not adhere may be provided between the first region 51 and the second region 52, and the first region 51 and the second region 52 may be disposed apart from each other. The present embodiment is not limited to the two regions of the first region 51 and the second region 52, and three or more regions to which the abrasive grains adhere may be provided. In this case, the average grain diameter of the abrasive grains in the most rearward region is the smallest.

In the cutting part 42 for forming holes in the glass body 20, an outer diameter of the second region 52 and an outer diameter of the first region 51 may have the same size. However, as illustrated in FIG. 3C, the outer diameter D2 of the second region 52 is preferably greater than the outer diameter D1 of the first region 51. This is because, after the first region 51 is provided with a hole in the glass body 20, the second region can reliably process the inner wall of this hole. Accordingly, the present embodiment can obtain a hole having a smooth inner wall.

Specifically, the difference between the outer diameter D2 of the second region 52 and the outer diameter D1 of the first region 51 (D2−D1) is in a range of 10 μm or greater and 300 μm or less. Since the difference between the outer diameter D2 of the second region 52 and the outer diameter D1 of the first region 51 is 10 μm or greater, even when the diamond grains of the second region 52 wear out after a plurality of times of use of the cutting tool 40, the second region 52 can continue to process the inner wall of the hole. In addition, since the difference between the outer diameter D2 of the second region 52 and the outer diameter D1 of the first region 51 is 300 μm or less, the load on the second region 52 during the processing does not increase, and the diamond grain wear of the second region 52 is reduced.

In a case of forming a total of seven holes in the glass body 20 at the same positions as the seven cores 11 described in FIG. 1, the cutting tool 40 is driven rotationally, and the cutting tool 40 is inserted into the glass body 20 from one end 21 to the other end 22 of the glass body 20 with the cutting part 42 disposed in the front side as the head. The glass material cut by the cutting part 42 is, for example, sent backward and discharged from the discharge path 50a.

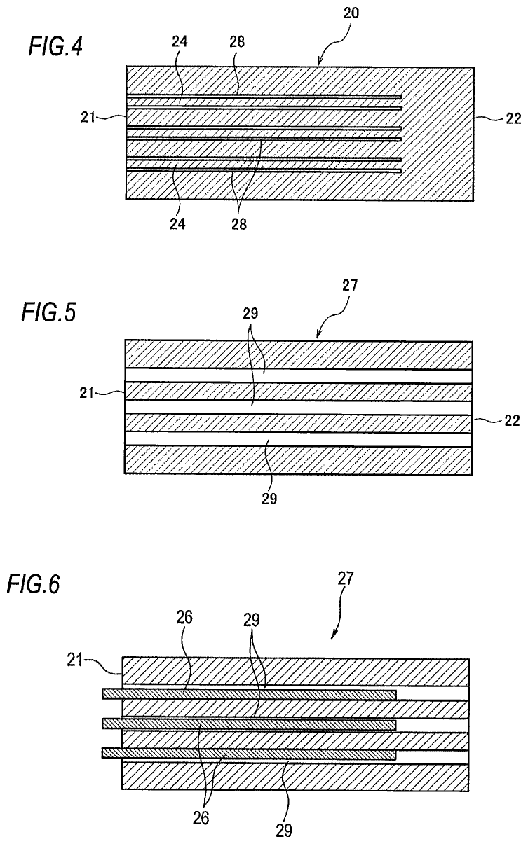

FIGS. 4 to 6 are sectional views including the center axes of the glass body 20 and a jacket material 27 in the manufacturing method of the optical fiber preform. A total of seven ring-shaped holes 28 are formed in the glass body 20 by the hollow round bar-shaped cutting tool 40. FIG. 4 illustrates an intermediate process in which the three ring-shaped holes 28 on the cross section are formed, among a total of seven holes. At the center of each ring-shaped hole 28, an uncut bar 24 remains. When the ring-shaped hole 28 reaches the other end 22, the bar 24 drops out and the ring-shaped hole 28 becomes a through hole 29 (FIG. 5). The through hole 29 corresponds to the hole in the present disclosure. The inner surface of the through hole 29 is cleaned by using, for example, fluorine gas.

Then, a total of seven core rods 26 are inserted into the through holes 29 respectively. FIG. 6 illustrates the three core rods 26 on the cross section. In this case, for example, the core rod 26 located at the center of the multi-core optical fiber 1 is disposed concentrically with the through hole 29 disposed on the center axis of the jacket material 27. The plurality of core rods 26 located in the outer circumferential core of the multi-core optical fiber 1 are disposed close to the center axis of the jacket material 27 in each corresponding through hole 29.

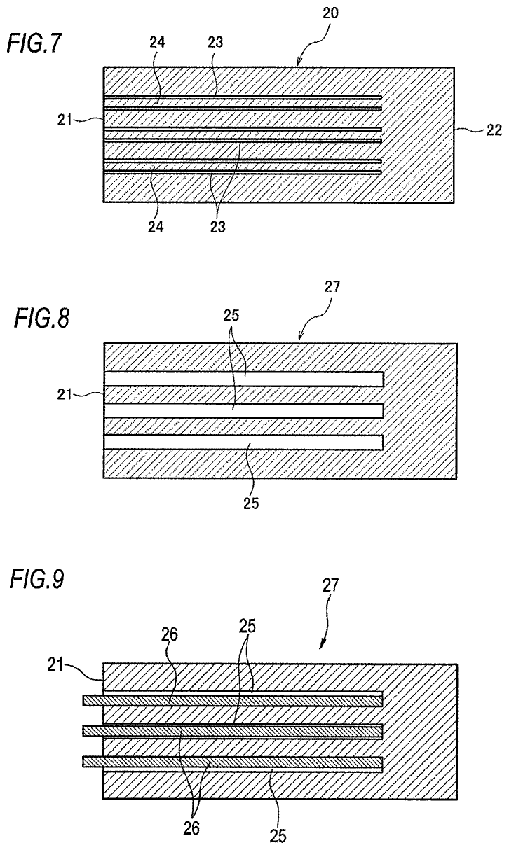

The holes in the present disclosure may not be through holes. In this case, a total of seven ring-shaped bottomed holes 23 are formed in the glass body 20. FIG. 7 illustrates the three ring-shaped bottomed holes 23 on the cross section. The ring-shaped bottomed hole 23 corresponds to the hole of the present disclosure. The ring-shaped bottomed hole 23 extends along the longitudinal direction and reaches a position where a predetermined thickness remains from the other end 22. In the glass body 20, the uncut bar 24, which is surrounded by the ring-shaped bottomed hole 23, remains.

Next, when the glass body 20 is heated from the outside, the bottom part of the bar 24 softens and melts, and thus, by cleaving the bottom part of the bar 24, a circular bottomed hole 25 is formed in the glass body 20 (FIG. 8). Then, the residues of the bottom part of the circular bottomed hole 25 are removed, for example, by using a rubbing tool or by irradiating a CO₂ laser. After this, the inside of the circular bottomed hole 25 is cleaned by using fluorine gas and the like to form the jacket material 27.

Then, a total of seven core rods 26 are inserted into the circular bottomed holes 25, respectively. FIG. 9 illustrates the three core rods 26 on the cross section. In this case, for example, the core rod 26 located at the center of the multi-core optical fiber 1 is disposed concentrically with the circular bottomed hole 25 disposed on the center axis of the jacket material 27. The plurality of core rods 26 located in the outer circumferential core of the multi-core optical fiber 1 are disposed close to the center axis of the jacket material 27 in each corresponding circular bottomed hole 25.

The core rod 26 is a glass bar with a higher refractive index than that of the jacket material 27, and is made by a vapor phase glass synthesis method such as the vapor phase axial deposition (VAD) method. In a case where the jacket material 27 is fluorine added silica glass, as the core rod 26, a core rod including the center core containing pure silica glass (which may contain chlorine) and an optical cladding surrounding this center core and containing fluorine added silica glass, is used. Meanwhile, in a case where the jacket material 27 is pure silica glass, as the core rod 26, a core rod including the center core containing GeO₂ added silica glass and an optical cladding surrounding this center core and containing pure silica glass to which GeO₂ is not added, is used.

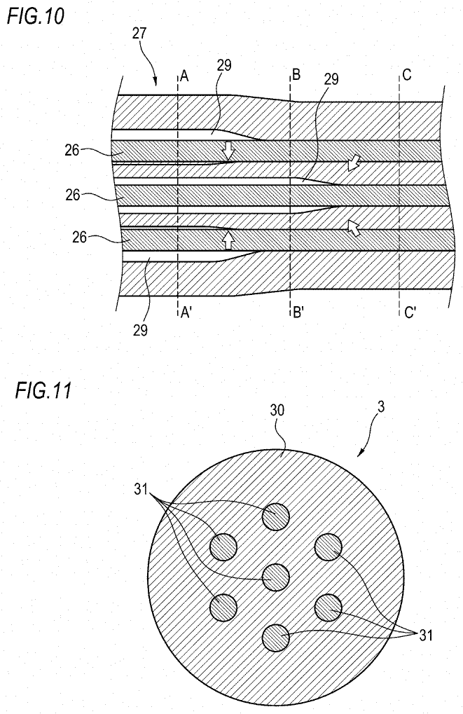

FIG. 10 is a conceptual view illustrating a process of integration according to the embodiment of the present disclosure. Next, the jacket material 27 is heated to integrate the core rod 26 with the jacket material 27. Specifically, the jacket material 27 in which the core rod 26 is inserted is rotating around the center axis of the jacket material 27, for example, and the heating source is moving in the axial direction of the jacket material 27 (from right to left in FIG. 10). When the jacket material 27 is heated, the inner diameter of the through hole 29 or the circular bottomed hole 25 shrinks due to surface tension, and the jacket material 27 is welded to the core rod 26.

A-A′ in FIG. 10 illustrates a position before the heating source passes through. The core rod 26 and the jacket material 27 are not yet integrated with each other. B-B′ in FIG. 10 illustrates a position where the heating source is passing through. The core rod 26 located in the outer circumferential core of the multi-core optical fiber 1 is already integrated with the jacket material 27. However, the core rod 26 located at the center of the multi-core optical fiber 1 is not yet integrated with the jacket material 27. C-C′ in FIG. 10 illustrates a position after the heating source has passed through. All of the core rods 26 and the jacket materials 27 are integrated with each other. In other words, at the position of C-C′ in FIG. 10, a multi-core optical fiber preform 3 has a sectional structure as illustrated in FIG. 11, and a cladding part 30 and a core part 31 are integrated with each other.

In this manner, in the rod-in collapse method, since the outer circumference of the jacket material 27 is close to the heating source, the outer circumference of the jacket material 27 is heated and deforms faster than the center of the jacket material 27. Therefore, as described at the position of B-B′ in FIG. 10, the through hole 29 or the circular bottomed hole 25 provided in the vicinity of the outer circumference of the jacket material 27 shrinks before the through hole 29 or the circular bottomed hole 25 provided at the center of the jacket material 27. In general, the inner wall of the hole becomes smoother as the inner circumference of the hole shrinks, but in a case of the through hole 29 or the circular bottomed hole 25 provided in the vicinity of the outer circumference of the jacket material 27, the through hole 29 or the circular bottomed hole 25 can come into contact with the core rod 26 before the roughness of a part of the inner wall of the through hole 29 or the circular bottomed hole 25 close to the center of the jacket material 27 becomes sufficiently small. In a case where the clearance between the inner diameter of the through hole 29 or the circular bottomed hole 25 and the outer diameter of the core rod 26 is small, the positional accuracy of the core part 31 described in FIG. 11 increases, but the through hole 29 or the circular bottomed hole 25 becomes more likely to come into contact with the core rod 26 before the roughness of the inner wall of the through hole 29 or the circular bottomed hole 25 becomes sufficiently small.

However, as described in FIGS. 3A to 3C, the grain diameter of the diamond grains in the second region 52 of the cutting tool 40 is smaller than the grain diameter of the diamond grains in the first region 51, and thus, the first region 51 ensures the productivity of the hole opening and the second region 52 reduces the roughness of the inner wall of the through hole 29 or the circular bottomed hole 25. Accordingly, the present embodiment can obtain the multi-core optical fiber preform 3 in which void is unlikely to remain at the boundary part between the inner wall of the through hole 29 or the circular bottomed hole 25 and the core rod 26 without deteriorating the productivity of the hole opening. Further, according to the present embodiment, by drawing the multi-core optical fiber preform 3 manufactured in this manner, it is possible to manufacture the multi-core optical fiber 1 in which the outer diameter variation decreases and the mechanical strength does not deteriorate.

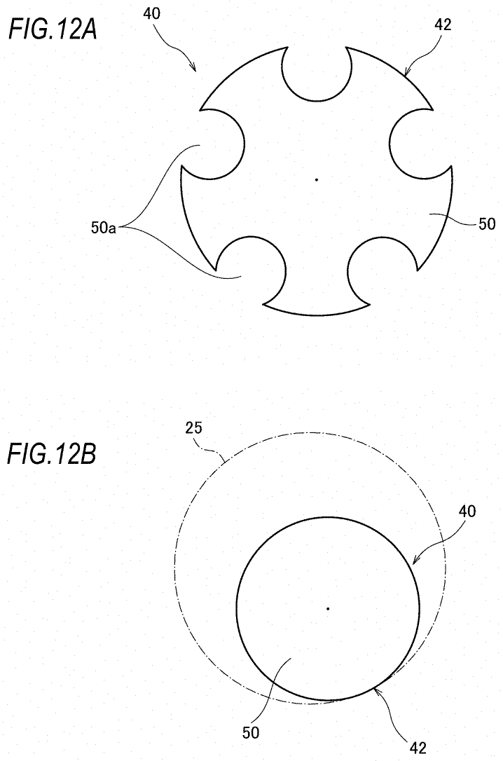

In the above-described Example, an example of the hollow round bar-shaped cutting tool 40 was described. However, the present disclosure is not limited to the example. For example, the cutting tool 40 may have a solid round bar-shape as illustrated in FIGS. 12A and 12B. The cutting tool 40 illustrated in FIG. 12a has, for example, five discharge paths 50a on the outer circumferential surface of the cutting part 42. The tip end surface 50 of the cutting part 42 is conical, for example.

In the cutting tool 40 illustrated in FIG. 12B, the cutting part 42 has a smaller diameter than that of the through hole 29 or the circular bottomed hole 25. The cutting part 42 and the hole, which is cut, are not concentric, and the cutting part 42 rotates around an eccentric position with respect to the center of the hole. In this case, since the cutting part 42 has a smaller diameter than that of the hole, a discharge path for the glass material may not be provided. The tip end surface 50 of the cutting part 42 may be conical or cross-shaped, for example.

In the above-described Example, the method for manufacturing the multi-core optical fiber preform 3 was described, but the present disclosure is also applicable to a case of manufacturing a single-core optical fiber preform.

It should be considered that the embodiments disclosed here are examples in all aspects and not restrictive. The scope of the present disclosure is indicated by the scope of claims, not the above-described meaning, and is intended to include all modifications within the scope and meaning equivalent to the claims.

### REFERENCE SIGNS LIST

1 . . . multi-core optical fiber

3 . . . multi-core optical fiber preform

10 . . . cladding

11 . . . core

20 . . . glass body

21 . . . one end

22 . . . another end

23 . . . ring-shaped bottomed hole

24 . . . uncut bar

25 . . . circular bottomed hole

26 . . . core rod

27 . . . jacket material

28 . . . ring-shaped hole

29 . . . through hole

30 . . . cladding part

31 . . . core part

40 . . . cutting tool

41 . . . shank part

42 . . . cutting part

50 . . . tip end surface

50a . . . discharge path

51 . . . first region

52 . . . second region

1. A cutting tool comprising:
a shank part; and
a cutting part provided at one end of the shank part,
wherein the cutting part includes a first region provided at one end of the cutting tool and a second region located closer to a center of the cutting tool than the first region,
abrasive grains adhere to the first region and the second region, and
an average grain diameter of the abrasive grains in the second region is smaller than an average grain diameter of the abrasive grains in the first region.

2. The cutting tool according to claim 1,
wherein the abrasive grains are diamond grains.

3. The cutting tool according to claim 1, wherein the average grain diameter of the abrasive grains in the first region is 100 μm or greater and the average grain diameter of the abrasive grains in the second region is less than 100 μm.

4. The cutting tool according to claim 1,
wherein an outer diameter of the second region is greater than an outer diameter of the first region.

5. The cutting tool according to claim 4,
wherein a difference between the outer diameter of the second region and the outer diameter of the first region is in a range of 10 μm or greater and 300 μm or less.

6. A method for manufacturing an optical fiber preform including a core extending in a longitudinal direction, the method comprising:
preparing a jacket material by forming a hole from one end to another end of a glass body in an axial direction of the glass body by using the cutting tool according to claim 1;
inserting a core rod into the hole; and
integrating the jacket material and the core rod with each other by heating the jacket material.
